(19) United States
(12) Patent Application Publication
(10) Pub. No.: US 2016/0169001 A1
(43) Pub. Date: Jun. 16, 2016

(54) DIFFUSED PLATFORM COOLING HOLES

(71) Applicant: UNITED TECHNOLOGIES CORPORATION, Hartford, CT (US)

(72) Inventors: Lane Thornton, Meriden, CT (US); Matthew Andrew Hough, West Hartford, CT (US)

(21) Appl. No.: 14/908,573

(22) PCT Filed: Aug. 14, 2014
(86) PCT No.: PCT/US2014/050977

§ 371 Date: Jan. 29, 2016

Related U.S. Application Data
(60) Provisional application No. 61/882,658, filed on Sep. 26, 2013.

(51) Int. Cl. F01D 5/18

(52) U.S. Cl. CPC F01D 5/186; F05D 2220/32; F05D 2240/81

(57) ABSTRACT

A gas turbine engine component has first and second components each having a platform with an upper surface and a lower surface and with a plurality of side faces extending between the upper and lower surfaces. The platforms are arranged adjacent to one another such that one side face of the platform faces a mating side face of an adjacent platform. At least one cooling hole is formed within the platform and has an inlet to receive a cooling flow and an outlet at least at one of the side faces. The at least one cooling hole increases in size in a direction toward the outlet. A method of cooling a gas turbine engine is also disclosed.

### CROSS-REFERENCE TO RELATED APPLICATION

This application claims priority to U.S. Provisional Application No. 61/882,658, filed Sep. 26, 2013.

### BACKGROUND

This disclosure relates to cooling of a platform component in a gas turbine engine. More particularly, the disclosure relates to cooling holes provided in a platform for a component such as an airfoil or blade outer air seal component, for example.

Gas turbine engines typically include a compressor section, a combustor section, and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

Cooling air provided to cool turbine hardware can adversely affect the overall performance of the engine. Thus, it is important to use cooling air in an effective manner to minimize any adverse effects on performance. One particularly challenging location to cool is along matefaces between the vane or blade platforms. Typically, holes are drilled into these areas that provide cooling air from an airfoil coolant supply. The holes have a consistent cross-section along their length.

### SUMMARY

In a featured embodiment, a gas turbine engine component has first and second components each having a platform with an upper surface and a lower surface and with a plurality of side faces extending between the upper and lower surfaces. The platforms are arranged adjacent to one another such that one side face of the platform faces a mating side face of an adjacent platform. At least one cooling hole is formed within the platform and has an inlet to receive a cooling flow and an outlet at least at one of the side faces. The at least one cooling hole increases in size in a direction toward the outlet.

In another embodiment according to the previous embodiment, the plurality of side faces comprises a leading edge face, a trailing edge face, and pressure and suction side matefaces. The platforms are arranged adjacent to one another such that the pressure side mateface of one platform faces the suction side mateface of an adjacent platform. The outlet is in the suction side or pressure side mateface.

In another embodiment according to any of the previous embodiments, the cooling hole is defined by a first cross-section at the inlet and a second cross-section at the outlet. The first cross-section is less than the second cross-section.

In another embodiment according to any of the previous embodiments, the first cross-section extends along a first length and the second cross-section extends along a second length that is different than the first length.

In another embodiment according to any of the previous embodiments, the first cross-section defines a minimum cross-sectional area for the cooling hole and the second cross-section defines a maximum cross-sectional area for the cooling hole.

In another embodiment according to any of the previous embodiments, the first cross-section extends along a first length and the second cross-section extends along a second length. The first cross-section remains generally constant along the first length.

In another embodiment according to any of the previous embodiments, the cooling hole has an increasing cross-sectional size as the cooling hole extends from an end of the first length to the end of the second length.

In another embodiment according to any of the previous embodiments, the at least one cooling hole has a plurality of cooling holes that each have a metering portion beginning at the inlet and a diffuser portion that terminates at the outlet.

In another embodiment according to any of the previous embodiments, the inlet receives the cooling flow from a passage formed within an associated one of the first and second airfoil components.

In another embodiment according to any of the previous embodiments, the first and second components comprise airfoil or blade outer air seal components.

In another featured embodiment, a method of cooling a gas turbine engine component includes the steps of providing cooling flow to adjacent components each having a platform with an upper surface and a lower surface and with a plurality of side faces extending between the upper and lower surfaces. The platforms are arranged adjacent to one another such that one side face of the platform faces a mating side face of an adjacent platform. The cooling flow is directed to an inlet of at least one cooling hole formed within at least one of the platforms. The cooling fluid is diffused through an outlet at least at one of the side faces.

In another embodiment according to the previous embodiment, the at least one cooling hole increases in size in a direction toward the outlet.

In another embodiment according to any of the previous embodiments, the plurality of side faces comprises a leading edge face, a trailing edge face, and pressure and suction side matefaces. The platforms are arranged adjacent to one another such that the pressure side mateface of one platform faces the suction side mateface of an adjacent platform. The outlet is in the suction side mateface or pressure side mateface.

In another embodiment according to any of the previous embodiments, the cooling hole is defined by a first cross-section at the inlet and a second cross-section at the outlet. The first cross-section is less than the second cross-section.

In another embodiment according to any of the previous embodiments, the first cross-section extends along a first length and the second cross-section extends along a second length that is different than the first length.

In another embodiment according to any of the previous embodiments, the first cross-section defines a minimum cross-sectional area for the cooling hole and the second cross-section defines a maximum cross-sectional area for the cooling hole.

In another embodiment according to any of the previous embodiments, the first cross-section remains generally constant long the first length.

In another embodiment according to any of the previous embodiments, the cooling hole has an increasing cross-sectional size as the cooling hole extends from an end of the first length to the end of the second length.

In another embodiment according to any of the previous embodiments, the components have airfoil or blade outer air seal components.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2 is a top perspective view of one example of cooling holes in a platform.

FIG. 3 is a side schematic view of the platform.

FIG. 4 is a schematic view of inlets to the cooling holes.

FIG. 5 is a schematic view of outlets from the cooling holes.

FIG. 6 is a perspective view of one example of a cooling hole.

FIG. 7 is a perspective view of one example of a cooling hole configuration in a platform of a blade outer air seal component.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

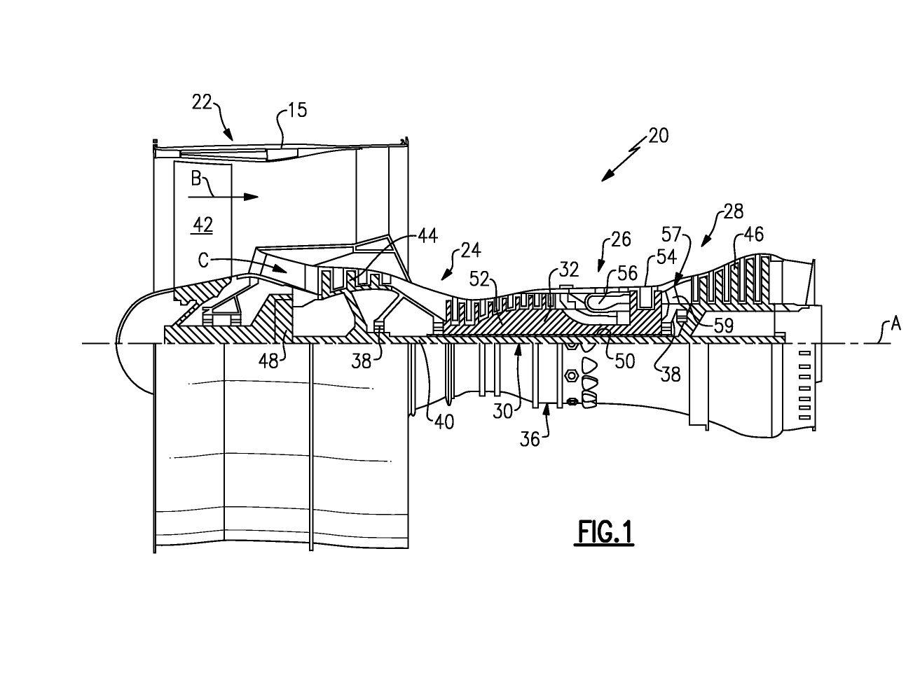

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

The disclosed cooling passage may be used in various gas turbine engine components. For exemplary purposes, a turbine blade 100 and platform 102 is described. It should be understood that the cooling passage may also be used in other areas such as vanes, for example.

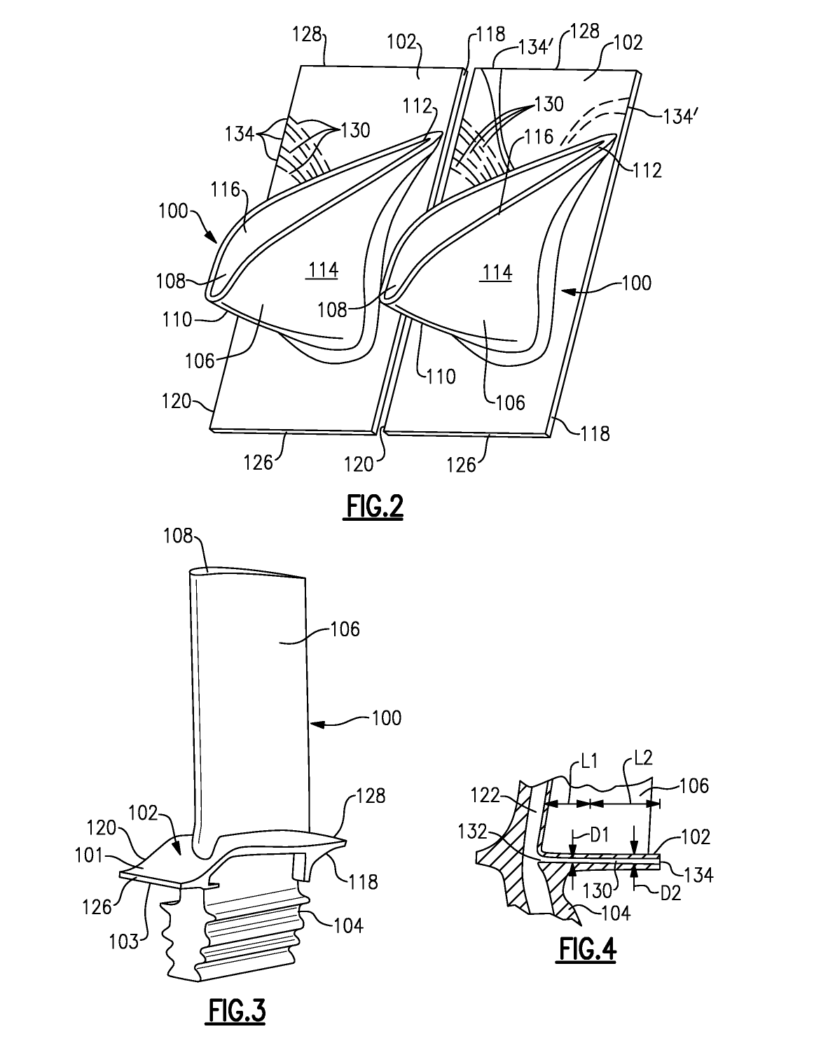

Referring to FIGS. 2-3, a root 104 of each turbine blade 100 is configured to be mounted to a rotor disk (not shown). The turbine blade 100 includes a platform 102, which provides the inner gas flow path, supported by the root 104. An airfoil 106 extends in a radial direction from the platform 102 to a tip 108. It should be understood that the turbine blades may be integrally formed with the rotor such that the roots are eliminated. In such a configuration, the platform is provided by the outer diameter of the rotor. The airfoil 106 provides leading 110 and trailing 112 edges. The tip 108 is arranged adjacent to a blade outer air seal. Multiple turbine blades 100 are arranged circumferentially in a circumferential direction about the rotor as known.

The airfoil 106 is provided between a pressure wall 114 (typically concave) and a suction wall 116 (typically convex). The platform 102 includes a pressure side mateface 118 and a suction side mateface 120. As shown in FIG. 2, the pressure side mateface 118 of one blade 100 faces the suction side mateface 120 of an adjacent blade 100. The platform 102 also includes a leading edge face 126 and a trailing edge face 128. The platform 102 includes an upper surface 101 and a lower surface 103 and with the plurality of faces 118, 120, 126, 128 extending between the upper 101 and lower 103 surfaces (FIG. 3).

As shown in FIG. 4, the blades 100 include one or more internal cooling passages 122 that receive cooling air flow. There is at least one cooling hole 130 formed within the platform 102 that receives cooling flow from the cooling passage 122. The cooling hole 130 has an inlet 132 to receive the cooling flow from the cooling passage 122 and an outlet 134 at one of the pressure 118 and suction 120 side matefaces or the trailing edge face 128. In the example shown in FIG. 2, there are a plurality of cooling holes 130 that have outlets 134 in the suction side mateface 120. It should be understood that the configuration shown in FIG. 2 is merely one example, and one or more outlets 134′ (FIG. 2) could be positioned at other locations such as the pressure side mateface 118 or trailing edge face 128, for example. In each of the examples, the cooling holes increase in size in a direction toward the outlet 134, 134′.

The cooling hole 130 is defined by a first cross-section D1 at the inlet 132 and a second cross-section D2 at the outlet 134, where the first cross-section is less than the second cross-section. In the example shown, the first cross-section D1 extends along a first length L1 and the second cross-section D2 extends along a second length L2 that is greater than the first length L1. The portion of the cooling hole 130 that extends along the first length L1 comprises a metering length that sets the flow rate into the platform 102. The portion of the cooling hole 130 that extends along the second length L2 comprises a diffusing portion that spreads the flow and slows the flow rate down before ejecting the flow out of the suction side mateface 120. In the example shown, the diffusing portion is orientated in a horizontal configuration; however, the diffusing portion could be orientated vertically or at any angle between the horizontal and vertical configurations. Further, while the second length L2 is shown as being greater than the first length L1, it should be understood that there are configurations where the first length L1 would be greater than the second length L2. For example, for cooling holes having a relatively long overall length, the second length L2 could be less than the first length L1.

The first cross-section D1 defines a minimum cross-sectional area for the cooling hole and the second cross-section D2 defines a maximum cross-sectional area for the cooling hole. The cross-sectional shape for each portion can comprise any of various shapes such as circular, square, rectangular, oval, etc.

In the non-limiting example shown, the first cross-section D1 comprises a circular section (FIG. 6) that generally remains constant along the first length L1, and the second cross-section D2 comprises an oval shape (FIG. 5). The cooling hole 130 comprises an increasing cross-sectional size as the cooling hole 130 extends from an end of the first length L1 to the end of the second length L2, i.e. the oval shape of the second cross-section D2 starts to continuously increase in size along the second length L2. As discussed above, this forms a metering portion beginning at the inlet 132 and a diffusing portion that terminates at the outlet 134. This allows for a precise control of the flow rate entering the platform 102 with a subsequent spreading or diffusing of the flow internally within the platform to better draw heat out of the platform 102.

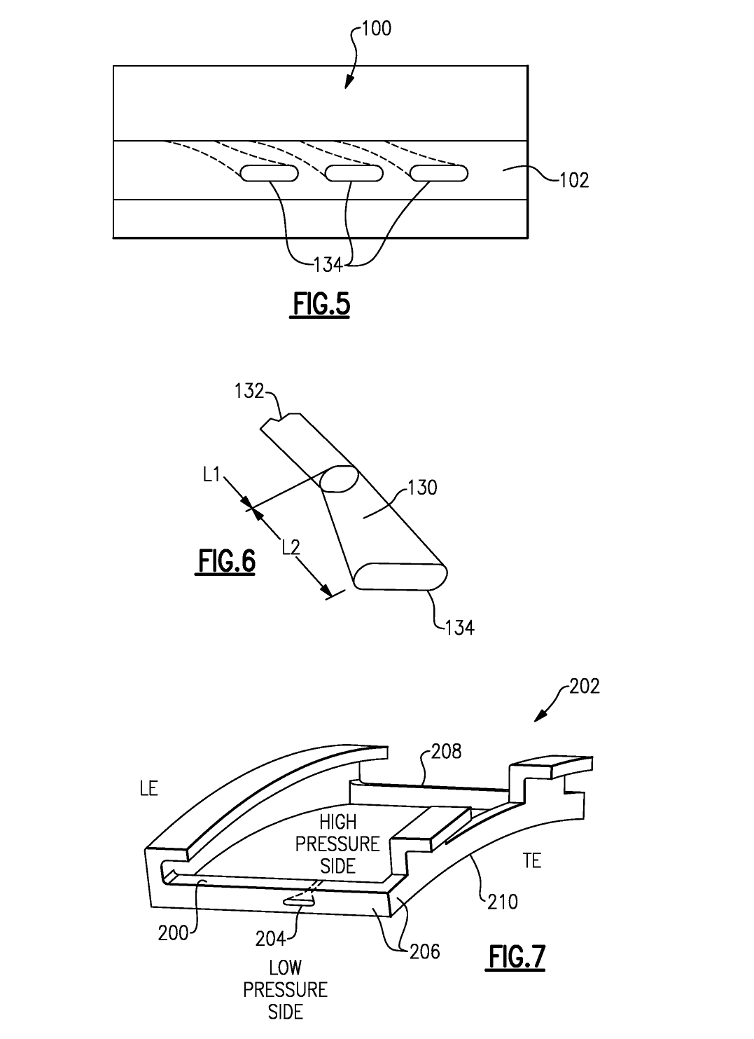

While FIG. 6 shows the cooling holes as used in an airfoil component, FIG. 7 shows an example where a platform 200 of a blade outer air seal (BOAS) component 202 includes a at least one cooling hole 204. The cooling hole 204 is formed within one of a plurality of platform matefaces 206 that extend between an upper surface 208 and lower surface 210. The cooling hole 204 is configured similar to the cooling hole 130 described above. Further, while only one cooling hole 204 is shown, it should be understood that the platform 200 could include a plurality of cooling holes 204.

A method of cooling the component array includes the steps of directing the cooling flow to the inlets 132 of the cooling holes 130 formed within the platforms 102, and diffusing the cooling fluid through the outlets 134 at one of the pressure 118 and suction 120 side matefaces. To provide the diffusing effect, the cooling holes 130 increase in size in a direction toward the outlet 134.

In one example, the cooling holes are drilled into the platform. The holes can be easily drilled through the pressure 118 and/or suction 120 side matefaces to have the desired shape. Other manufacturing methods could also be used; however, drilling provides the most cost effective method.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although example embodiments have been disclosed, a worker of ordinary skill in this art would recognize that certain modifications would come within the scope of the claims. For that and other reasons, the following claims should be studied to determine their true scope and content.

What is claimed is:

1. A gas turbine engine component comprising:
first and second components each having a platform with an upper surface and a lower surface and with a plurality of side faces extending between the upper and lower surfaces, the platforms being arranged adjacent to one another such that one side face of the platform faces a mating side face of an adjacent platform; and
at least one cooling hole formed within the platform, the at least one cooling hole having an inlet to receive a cooling flow and an outlet at least at one of side faces of the platform, and wherein the at least one cooling hole increases in size in a direction toward the outlet.

2. The gas turbine engine component according to claim 1, wherein the plurality of side faces comprises a leading edge face, a trailing edge face, and pressure and suction side matefaces, and wherein the platforms are arranged adjacent to one another such that the pressure side mateface of one platform faces the suction side mateface of an adjacent platform, and wherein the outlet is in the suction side or pressure side mateface.

3. The gas turbine engine component according to claim 1, wherein the cooling hole is defined by a first cross-section at the inlet and a second cross-section at the outlet, the first cross-section being less than the second cross-section.

4. The gas turbine engine component according to claim 3, wherein the first cross-section extends along a first length and the second cross-section extends along a second length that is different than the first length.

5. The gas turbine engine component according to claim 3, wherein the first cross-section defines a minimum cross-sectional area for the cooling hole and the second cross-section defines a maximum cross-sectional area for the cooling hole.

6. The gas turbine engine component according to claim 3, wherein the first cross-section extends along a first length and the second cross-section extends along a second length, and wherein the first cross-section remains generally constant along the first length.

7. The gas turbine engine component according to claim 6, wherein the cooling hole comprises an increasing cross-sectional size as the cooling hole extends from an end of the first length to the end of the second length.

8. The gas turbine engine component according to claim 1, wherein the at least one cooling hole comprises a plurality of cooling holes that each have a metering portion beginning at the inlet and a diffuser portion that terminates at the outlet.

9. The gas turbine engine component according to claim 8, wherein the inlet receives the cooling flow from a passage formed within an associated one of the first and second airfoil components.

10. The gas turbine engine component according to claim 1, wherein the first and second components comprise airfoil or blade outer air seal components.

11. A method of cooling a gas turbine engine component comprising the steps of:
providing cooling flow to adjacent components each having a platform with an upper surface and a lower surface and with a plurality of side faces extending between the upper and lower surfaces, with the platforms being arranged adjacent to one another such that one side face of the platform faces a mating side face of an adjacent platform;
directing the cooling flow to an inlet of at least one cooling hole formed within at least one of the platforms; and
diffusing the cooling fluid through an outlet at least at one of the side faces.

12. The method according to claim 11, wherein the at least one cooling hole increases in size in a direction toward the outlet.

13. The method according to claim 11, wherein the plurality of side faces comprises a leading edge face, a trailing edge face, and pressure and suction side matefaces, and wherein the platforms are arranged adjacent to one another such that the pressure side mateface of one platform faces the suction side mateface of an adjacent platform, and wherein the outlet is in the suction side mateface or pressure side mateface.

14. The method according to claim 11, wherein the cooling hole is defined by a first cross-section at the inlet and a second cross-section at the outlet, the first cross-section being less than the second cross-section.

15. The method according to claim 14, wherein the first cross-section extends along a first length and the second cross-section extends along a second length that is different than the first length.

16. The method according to claim 15, wherein the first cross-section defines a minimum cross-sectional area for the cooling hole and the second cross-section defines a maximum cross-sectional area for the cooling hole.

17. The method according to claim 16, wherein the first cross-section remains generally constant long the first length.

18. The method according to claim 17, wherein the cooling hole comprises an increasing cross-sectional size as the cooling hole extends from an end of the first length to the end of the second length.

19. The method according to claim 11, wherein the components comprise airfoil or blade outer air seal components.
